(19) United States
(12) Patent Application Publication
(10) Pub. No.: US 2001/0035908 A1
(43) Pub. Date: Nov. 1, 2001

(54) Auto exposing apparatus for use in image sensor

(76) Inventor: Joon-Hwan Kim, Ichon-shi (KR)

Correspondence Address: Pillsbury Winthrop LLp, Intellectual Property Group, Ninth Floor, 1100 New York Avenue, NW., Washington, DC, 20005-3918, US

(21) Appl. No.: 09/751,451

(22) Filed: Jan. 2, 2001

(30) Foreign Application Priority Data
Dec. 30, 1999 (KR) 1999-66912

(51) Int. Cl. H04N 5/235

(52) U.S. Cl. 348/221

(57) ABSTRACT

An auto exposing arrangement is capable of controlling exposure time. A number of first pixels are identified, each of which outputs image data having a luminance value higher than a predetermined level. A number of second pixels are identified, each of which outputs image data having a luminance value lower than the predetermined level. Exposure time is controlled based on those identified numbers of pixels. A first counter receives image data from an image sensor for counting the number of the first pixels for a unit frame. A second counter receives image data from the image sensor for counting the number of the second pixels for the unit frame. A look up table stores an optimum exposure time for each luminance level. A brightness analyzer determines whether the screen is to be controlled to brighter or darker in response to the numbers of the pixels identified by the first and second counters, respectively, and selects the luminance level of the screen to output as an address of the look up table. An exposure time corresponding to the address output from the brightness analyzer is output to the image sensor to control the exposure time of the pixels.

### BACKGROUND

1. Field of the Invention

The present invention relates to an image sensor, and, more particularly, to an auto exposing apparatus for controlling exposure time during which a pixel array of an image sensor is exposed to light.

2. General Background and Related Art

Generally, exposure time for a pixel array of an image sensor is controlled depending on the amount of light in a field being imaged. This is similar to a film camera exposing film longer to image a dark field of view and exposing the film a shorter length of time to image a bright field of view. Using an array of light sensitive pixel elements, the pixel array should be exposed to light for a relatively longer time when a field to be imaged is relatively dark place and the pixel array should be exposed to light for a relatively shorter time when the field to be imaged is relatively bright.

It is known to control exposure time based on a comparison of an average of luminance Y of an image frame with a luminance target Y.

FIG. 1 (Prior Art) is a block diagram of a known auto exposing apparatus. Auto exposing apparatus 100 includes an image frame Y average computation unit 110 receiving image data from an image sensor 10. Y average computation unit 110 computes an average of luminance Y for an image frame. A comparison and determining unit 120 compares the average of luminance Y from unit 110 with a predetermined level to determine whether exposure time should be adjusted. An exposure time adjusting unit 130 adjusts exposure time in response to the comparison result from the comparison and determining unit 120 by an appropriate amount and outputs the adjusted exposure time to the image sensor 10.

After receiving the image data from the image sensor 10 and computing the average luminance Y at unit 110, the comparison and determining unit 120 compares the computed average of the Y for the frame being imaged with the target Y and determines whether the exposure time is to be adjusted. When the exposure time is to be adjusted due to excessive brightness or darkness of the screen, the exposure time adjusting unit 130 adjusts the exposure time by the predetermined amount and then outputs the adjusted exposure time to the image sensor 10 so as to control the exposure time.

However, because the average of the luminance Y should be computed for every frame being imaged, there is a heavy computation load on the hardware. It takes long time to determine the correct exposure time because a number of repetitions are required to obtain an optimum exposure time depending on changes of light level.

### SUMMARY

The inventions claimed herein feature, at least in part, an auto exposing arrangement that is simpler and more efficient than known auto exposing arrangements. A number of first pixels are identified, each of which outputs image data having a luminance value higher than a predetermined level. A number of second pixels are identified, each of which outputs image data having a luminance value lower than the predetermined level. Exposure time is controlled based on those identified numbers of pixels. A first counter receives image data from an image sensor for counting the number of the first pixels for a unit frame. A second counter receives image data from the image sensor for counting the number of the second pixels for the unit frame. A look up table stores an optimum exposure time for each luminance level. A brightness analyzer determines whether the screen is to be controlled to brighter or darker in response to the numbers of the pixels identified by the first and second counters, respectively, and selects the luminance level of the screen to output as an address of the look up table. An exposure time corresponding to the address output from the brightness analyzer is output to the image sensor to control the exposure time of the pixels.

### BRIEF DESCRIPTION OF THE DRAWINGS

The above and other objects and features of the instant invention will become apparent from the following description of preferred embodiments taken in conjunction with the accompanying drawings, in which:

FIG. 1 (Prior Art) is a block diagram of a known auto exposing apparatus;

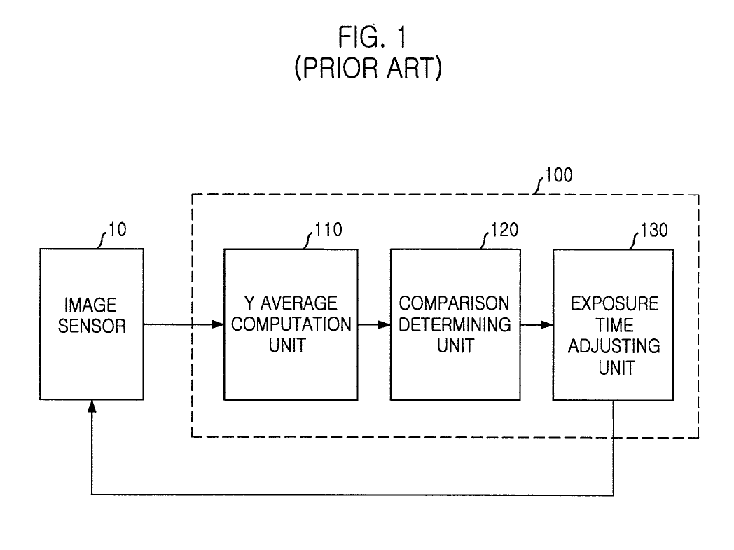

FIG. 2 shows a block diagram of an auto exposing apparatus in accordance with the present invention; and

FIG. 3 is a detailed block diagram of brightness analyzer 230 shown in FIG. 2.

### DETAILED DESCRIPTION

Exemplary embodiments of the claimed inventions will be described in detail with reference to the accompanying drawings.

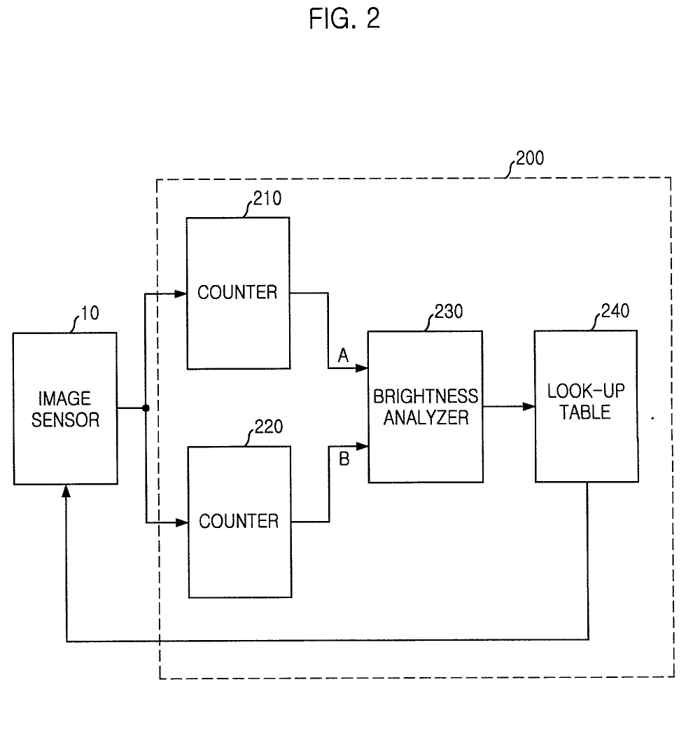

FIG. 2 is a block diagram of an auto exposing apparatus in accordance with the present invention. The auto exposing apparatus 200 includes a counter 210 that receives image data from an image sensor 10. Counter 210 counts the number A of first pixels for a frame to be imaged. The first pixels are identified as such because each has a luminance level that is higher than a first predetermined level. A counter 220 receives the image data from the image sensor 10 for counting the number B of second pixels for frame to be imaged. The second pixels are identified as such because each has a luminance value that is lower than a second predetermined level. The first and second predetermined levels can be the same or they can be different. A look-up table 240 stores an optimum exposure time for each potential luminance level. A brightness analyzer 230 determines whether the field being imaged is to be controlled to be brighter or darker in response to the numbers A and B counted by counters 210 and 220, respectively and selects the luminance level of the field being imaged to output as an address of the look-up table 240.

Counter 210 receives the image data from the image sensor 10 and counts the number A of the first pixels for the frame. Counter 220 receives the image data from the image sensor 10 and counts the number B of the second pixels for the frame. The numbers A and B of the pixels counted by the counters 210 and 220, respectively, are applied to the brightness analyzer 230 that determines whether the exposure time is to be adjusted in response to the numbers A and B and outputs the address of the look-up table 240 as the selected screen luminance level. The exposure time corresponding to the address outputted from the brightness analyzer 230 is outputted to the image sensor 10 so as to control the exposure time for the pixels of the image sensor. Look-up table 240 can be implemented by a ROM (Read Only Memory) or a PROM (Programmable Read Only Memory) and the stored exposure times are optimized by simulating the image sensor.

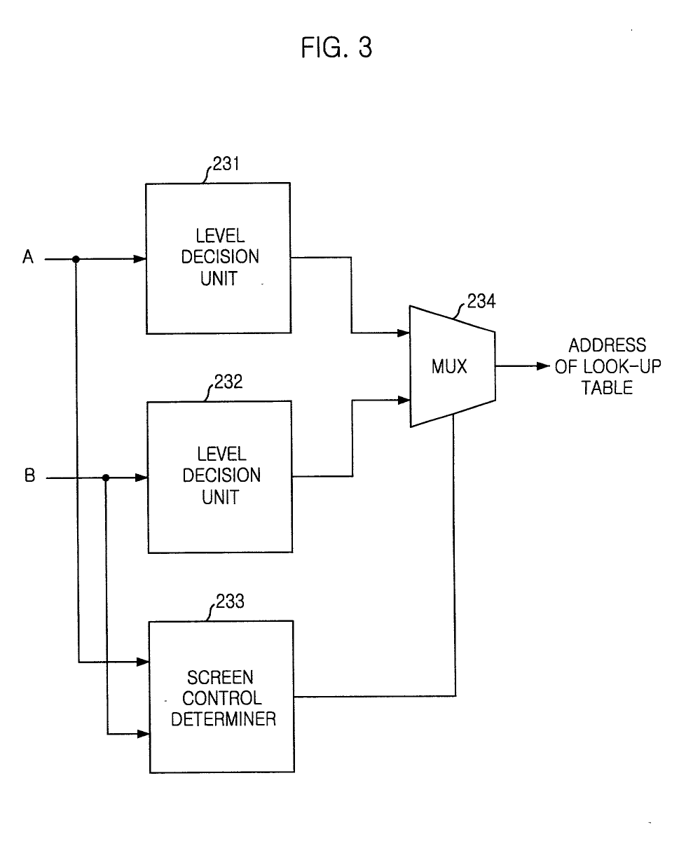

FIG. 3 is a more detailed block diagram of the brightness analyzer 230 in FIG. 2 according to an embodiment of the present invention. Brightness analyzer 230 includes a level decision unit 231 for deciding the brightness level of a bright screen in response to the number A of the first pixels for the unit frame. Level decision unit 232 decides the darkness level of a dark screen in response to the number B of the second pixels for the unit frame, A screen control determiner 233 determines whether the screen is to be controlled to brighter or darker in response to the numbers A and B of the pixels, outputted respectively from the counters 210 and 220. A multiplexer 234 selects, in response to a screen control determining signal from the screen control determiner 233, the address of the look-up table 240 corresponding to the level of the screen brightness outputted from the level decision unit 231 for the bright screen or the level decision unit 232 for the dark screen.

Screen control determiner 233 determines whether the screen is to be controlled to be brighter or darker by comparing the number A with the number B. When the screen is to be controlled to be brighter, the multiplexer 234 selects, in response to the screen control determining signal from the screen control determiner 233, the address of the look-up table 240 corresponding to the level of the screen brightness outputted from the level decision unit 231 for the bright screen. If the screen is to be controlled to be darker, the multiplexer 234 selects, in response to a screen control determining signal from the screen control determiner 233, the address of the look-up table 240 corresponding to the level of the screen darkness outputted from the level decision unit 232 for the dark screen.

As described above, the present invention is capable of for controlling exposure time by obtaining the number A of the first pixels for the unit frame, each of the first pixels outputting image data of which luminance is higher than a predetermined level, and the number B of the second pixels for the unit frame, each of the second pixels outputting image data of which luminance is lower than the predetermined level, and controlling the exposure time in response to the numbers A and B.

While the present invention has been shown and described with respect to the particular embodiments, it will be apparent to those skilled in the art that many changes and modifications may be made without departing from the spirit and scope of the invention as defined in the appended claims.

What is claimed is:

1. An auto exposing apparatus for an image sensor, the apparatus comprising:
first counting means receiving image data from an image sensor for counting a number of first pixels for an image frame, each of the first pixels having a luminance value associated therewith that is higher than a first predetermined level;
second counting means receiving image data from the image sensor for counting a number of second pixels for an image frame, each of the second pixels having a luminance value associated therewith that is lower than a second predetermined level;
storing means for storing an optimum exposure time for each luminance level; and
brightness analyzing means for determining whether the image frame is to be controlled to be brighter or darker in response to the numbers of first and second pixels, and selecting the luminance level of the field output as an address of the storing means,
wherein a exposure time corresponding to the address outputted from the brightness analyzing means is output to the image sensor to control the exposure time of the pixels.

2. An apparatus according to claim 1, wherein the brightness analyzing means includes:
a first level decision unit for deciding the brightness level of a bright screen in response to the number of first pixels;
a second level decision unit for deciding the darkness level of a dark screen in response to the number of the second pixels;
screen control determining means for determining whether the image frame is to be controlled to brighter or darker in response to the numbers of the first and second pixels and outputting a screen control determining signal indicative thereof; and
selecting means for selecting an address of the storing means in response to the screen control determining signal and an output of one of the level decision units.

3. An apparatus according to claim 1 wherein the first and second predetermined levels are the same.

4. An apparatus according to claim 1 wherein the first and second predetermined levels are different.

5. An auto exposing apparatus for an image sensor, the apparatus comprising:
a first counter constructed and arranged to receive image data from an image sensor for counting a number of first pixels for an image frame, each of the first pixels having a luminance value associated therewith that is higher than a first predetermined level;
a second counter constructed and arranged to receive image data from the image sensor for counting a number of second pixels for an image frame, each of the second pixels having a luminance value associated therewith that is lower than a second predetermined level;
a look up table storing an optimum exposure time for each luminance level; and
brightness analyzer constructed and arranged to determine whether an imaged field is to be controlled to be brighter or darker in response to the numbers of first and second pixels, and selecting luminance level of the field output as an address of the storing means,
wherein a exposure time corresponding to the address outputted from the brightness analyzing means is output to the image sensor to control the exposure time of the pixels.

6. An apparatus according to claim 5, wherein the brightness analyzer means includes:
a first level decision unit for deciding the brightness level of a bright screen in response to the number of first pixels;
a second level decision unit for deciding the darkness level of a dark screen in response to the number of the second pixels;
a screen control determiner constructed and arranged to determine whether the image field is to be controlled to be brighter or darker in response to the numbers of the first and second pixels and outputting a screen control determining signal indicative thereof; and
a selector constructed and arranged to select an address of the look up table in response to the screen control determining signal and an output of one of the level decision units.

7. An apparatus according to claim 5 wherein the first and second predetermined levels are the same.

8. An apparatus according to claim 5 wherein the first and second predetermined levels are different.

9. An apparatus according to claim 5 wherein the look up table is a ROM.

10. An apparatus according to claim 5 wherein the look up table is a PROM.

11. A method for auto exposing apparatus an image sensor, comprising:
receiving image data from an image sensor;
counting a number of first pixels for an image frame, each of the first pixels having a luminance value associated therewith that is higher than a first predetermined level;
counting a number of second pixels for an image frame, each of the second pixels having a luminance value associated therewith that is lower than a second predetermined level;
storing an optimum exposure time for each luminance level;
analyzing whether the image frame is to be controlled to be brighter or darker in response to the numbers of first and second pixels, and selecting the optimum luminance level of the field; and
controlling exposure time based on the optimum luminance level.
